(19) United States
(12) Patent Application Publication
(10) Pub. No.: US 2026/0189172 A1
(43) Pub. Date: Jul. 2, 2026

(54) CONTROLLER FOR AC ROTARY ELECTRIC MACHINE

(71) Applicant: Mitsubishi Electric Corporation, Tokyo (JP)

(72) Inventors: Kotaro NAKANO, Tokyo (JP); Keiichi ENOKI, Tokyo (JP); Tomoya TACHIBANA, Tokyo (JP); Masahiro IEZAWA, Tokyo (JP)

(73) Assignee: Mitsubishi Electric Corporation, Tokyo (JP)

(21) Appl. No.: 18/855,410

(22) PCT Filed: Oct. 25, 2022
(86) PCT No.: PCT/JP2022/039643

§ 371 Date: Oct. 9, 2024

(30) Foreign Application Priority Data
Jun. 2, 2022 (JP) 2022-090025

(51) Int. Cl. H02P 29/50; H02P 27/08

(52) U.S. Cl. CPC H02P 29/50; H02P 27/08

(57) ABSTRACT

To provide a controller for an AC rotary electric machine which can suppress low frequency components such as current generated at a specific carrier signal number. A controller for an AC rotary electric machine changes one or both of a carrier period and an update period so that an evaluation value does not coincide with a specific value at which components of frequencies lower than the AC period increases in one or more of current, voltage, and power supplied to the plural-phase windings, and wherein the evaluation value is calculated based on a carrier signal number which is a value obtained by dividing the AC period of the AC voltage command values by the carrier period, and the update period.

### TECHNICAL FIELD

The present disclosure relates to a controller for an AC rotary electric machine.

### BACKGROUND ART

A controller for an AC rotary electric machine turns on and off the switching devices of an inverter by PWM control (Pulse Width Modulation). A control method which reduces the inverter loss is desired. The inverter loss includes the switching loss and the conduction loss. The switching loss is a loss caused by the on/off operation of the switching devices, and the conduction loss is a loss caused when a current is conducted in the switching devices. If the carrier frequency of the PWM control is reduced, and the number of on and off times of the switching devices is reduced, the switching loss can be reduced. However, if the carrier frequency is reduced too much, the control becomes unstable.

In order to secure the control stability while reducing the switching loss, for example, in patent document 1, when a carrier signal number which is a number of vibration of the carrier signal during the AC period is reduced, it is switched to the synchronous PWM mode in which the carrier frequency is set to a natural number times of the AC frequency.

In patent document 2, a control is performed to avoid that the frequency which becomes the maximum depending on the power source angular frequency among the electromagnetic noises caused by the switching frequency becomes greater than or equal to a predetermined value.

### CITATION LIST

### Patent Literature

Patent document 1: JP 4205157 B
Patent document 2: JP 2013-198342 A

### SUMMARY OF INVENTION

### Technical Problem

When the controller controls in an overmodulation state where a vibration range of the AC voltage command value exceeds a vibration range of the carrier signal, and controls in a low carrier signal number in order to improve the inverter output and reduce the switching loss, the inventor found that low frequency components in one or more of current, voltage, and power increase, when the carrier signal number is a specific carrier signal number. However, patent documents 1 and 2 do not disclose a method for solving such phenomenon.

Then, the purpose of the present disclosure is to provide a controller for an AC rotary electric machine which can suppress low frequency components such as current generated at a specific carrier signal number.

### Solution to Problem

A controller for an AC rotary electric machine according to the present disclosure that controls the AC rotary electric machine which is provided with plural-phase windings via an inverter, the controller for the AC rotary electric machine including:
a voltage command calculation unit that calculates and updates AC voltage command values of plural-phase applied to the plural-phase windings at an update period;
a PWM control unit that generates a carrier signal which has an amplitude according to a DC voltage supplied to the inverter and vibrates at a carrier period, and controls on/off a plurality of switching devices of the inverter, based on a comparison result between the carrier signal and each of the AC voltage command values of plural-phase; and
a period change unit that changes one or both of the carrier period and the update period,
wherein the period change unit changes one or both of the carrier period and the update period so that an evaluation value does not coincide with a specific value at which components of frequencies lower than an AC period increases in one or more of current, voltage, and power supplied to the plural-phase windings, and wherein the evaluation value is calculated based on a carrier signal number which is a value obtained by dividing the AC period of the AC voltage command values by the carrier period, and the update period.

### Advantage of Invention

According to the controller for the AC rotary electric machine of the present disclosure, since the low frequency components will increase when the evaluation value calculated based on the carrier signal number and the update period coincides with the specific value, the low frequency components such as current can be suppressed from increasing, by changing one or both of the carrier period and the update period so that the evaluation value does not coincide with the specific value.

### BRIEF DESCRIPTION OF THE DRAWINGS

FIG. 1 is a schematic configuration diagram of the AC rotary electric machine and the controller for the AC rotary electric machine according to Embodiment 1;

FIG. 2 is a schematic block diagram of the controller for the AC rotary electric machine according to Embodiment 1;

FIG. 3 is a hardware configuration diagram of the controller for the AC rotary electric machine according to Embodiment 1;

FIG. 4 is a time chart explaining the control behavior according to the comparative example of Embodiment 1;

FIG. 5 is a time chart explaining the control behavior at P=11 and n=1 according to the comparative example of Embodiment 1;

FIG. 6 is a time chart explaining the control behavior at P=11 and n=2 according to the comparative example of Embodiment 1;

FIG. 7 is a figure explaining the magnitude of the offset component of the phase current with respect to the change of the carrier signal number P at n=1 and n=2 according to the comparative example of Embodiment 1;

FIG. 8 is a time chart explaining the control behavior at N=5 and n=1 according to the comparative example of Embodiment 1;

FIG. 9 is a time chart explaining the control behavior at N=10 and n=2 according to the comparative example of Embodiment 1;

FIG. 10 is a figure explaining the magnitude of 1/N with respect to the change of the carrier signal number P at n=1 according to the comparative example of Embodiment 1;

FIG. 11 is a time chart explaining the control behavior at N=7 and n=1 in the overmodulation state according to the comparative example of Embodiment 1;

FIG. 12 is a time chart explaining the control behavior at N=7 and n=1 in the normal modulation state according to the comparative example of Embodiment 1;

FIG. 13 is a figure explaining the region of the overmodulation state and the region of the normal modulation state according to Embodiment 1;

FIG. 14 is a figure explaining the setting of the carrier period based on the AC period according to Embodiment 1;

FIG. 15 is a figure explaining the setting of the carrier period based on the AC period according to Embodiment 1;

FIG. 16 is a figure explaining the random setting of the carrier period according to Embodiment 1;

FIG. 17 is a figure explaining the setting of the update period based on the AC period according to Embodiment 1;

FIG. 18 is a figure explaining the setting of the update period based on the AC period according to Embodiment 1; and

FIG. 19 is a figure explaining the setting of the carrier period when the synchronous PWM mode is executed according to Embodiment 1.

### DETAILED DESCRIPTION OF THE EMBODIMENTS

### 1. Embodiment 1

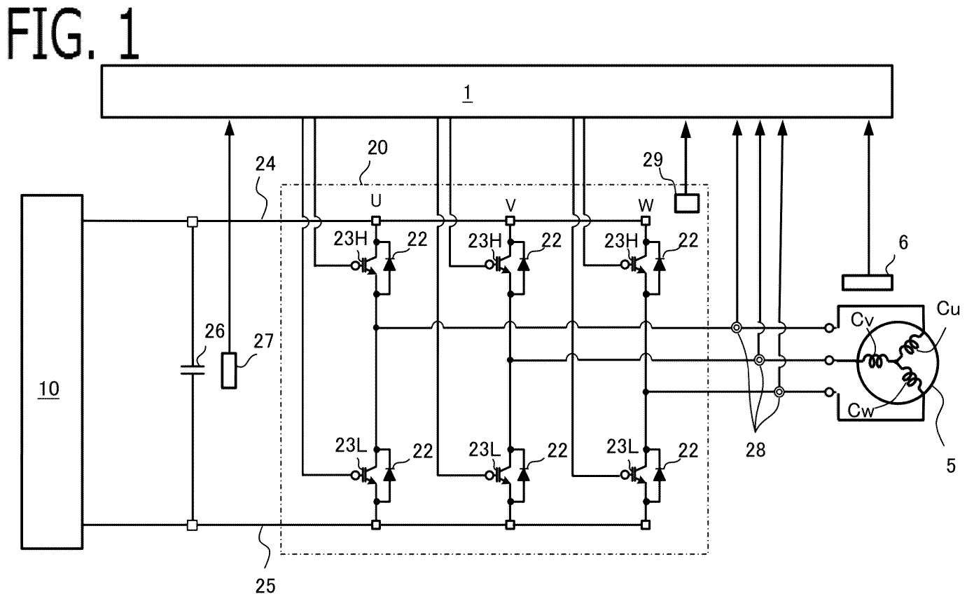

A controller for an AC rotary electric machine (hereinafter, referred to simply as the controller 1) according to Embodiment 1 will be explained with reference to drawings. FIG. 1 is a schematic configuration diagram of the AC rotary electric machine 5 and the controller 1 according to the present embodiment.

### 1-1. AC Rotary Electric Machine

The AC rotary electric machine 5 is provided with plural-phase windings. The AC rotary electric machine 5 is provided with a stator and a rotor, and the plural-phase windings are provided in the stator. In the present embodiment, three-phase windings Cu, Cv, Cw of U phase, V phase, and W phase are provided. The three-phase windings Cu, Cv, Cw are connected by star connection. The three-phase windings may be connected by delta connection. The AC rotary electric machine 5 is a permanent magnet type synchronous rotary machine in which a permanent magnet is provided in the rotor. For example, a rare earth permanent magnet, such as neodymium and samarium cobalt, is used for the permanent magnet, but various kinds of permanent magnets, such as an inexpensive ferrite magnet, may be used. The AC rotary electric machine 5 may be a field winding type synchronous rotary machine in which a field winding is provided in the rotor. Alternatively, the AC rotary electric machine 5 may be an induction rotary machine in which an electric cage type electric conductor is provided in the rotor.

The AC rotary electric machine 5 is provided with a rotation sensor 6 which outputs an electric signal according to a rotational angle of the rotor. The rotation sensor 6 is a Hall element, an encoder, or a resolver. An output signal of the rotation sensor 6 is inputted into the controller 1.

### 1-2. Inverter

The inverter 20 is an electric power converter which performs power conversion between the DC power source 10 and the three-phase windings, and is provided with a plurality of switching devices. The inverter 20 is provided with three sets of series circuits (leg) in each of which a high potential side switching device 23H (upper arm) connected to the high potential side of the DC power source 10 and a low potential side switching device 23L (lower arm) connected to the low high potential side of the DC power source 10 are connected in series, corresponding to each phase of three-phase. The inverter 20 is provided with a total of six switching devices of the three high potential side switching devices 23H, and the three low potential side switching devices 23L. Then, a connection node where the high potential side switching device 23H and the low potential side switching device 23L are connected in series is connected to the winding of the corresponding phase.

Specifically, in each phase of the series circuit, a collector terminal of the high potential side switching device 23H is connected to a high potential side wire 24, an emitter terminal of the high potential side switching device 23H is connected to a collector terminal of the low potential side switching device 23L, and an emitter terminal of the low potential side switching device 23L is connected to a low potential side electric wire 25. The connection node between the high potential side switching device 23H and the low potential side switching device 23L is connected to the winding of the corresponding phase.

IGBT (Insulated Gate Bipolar Transistor) in which a diode 22 is connected in inverse parallel, MOSFET (Metal Oxide Semiconductor Field Effect Transistor) which has a function of diode connected in inverse parallel, or the like is used for the switching device. A gate terminal of the each switching device is connected to the controller 1. The each switching device is turned on or turned off by the control signal outputted from the controller 1.

A smoothing capacitor 26 is connected between the high potential side wire 24 and the low potential side wire 25. A voltage sensor 27 which detects a DC voltage VDC supplied to the inverter 20 from the DC power source 10 is provided. The voltage sensor 27 is connected between the high potential side wire 24 and the low potential side wire 25. An output signal of the voltage sensor 27 is inputted into the controller 1.

The current sensor 28 outputs an electric signal according to current which flows into the winding of each phase. The current sensor 28 is provided on the each phase wire which connects the series circuit of the switching devices and the winding. An output signal of the current sensor 28 is inputted into the controller 1. The current sensor 28 may be provided in the series circuit of each phase.

The DC power source 10 outputs the DC voltage VDC to the inverter 20. The DC power source 10 may be any apparatus which outputs the DC voltage VDC, such as a battery, a DC-DC converter, a diode rectifier, and a PWM rectifier.

### 1-3. Controller

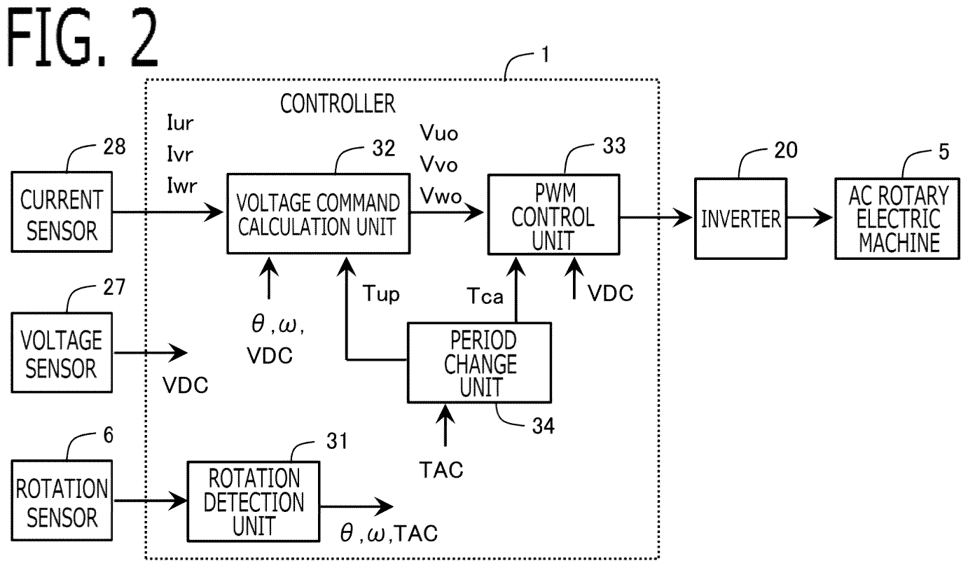

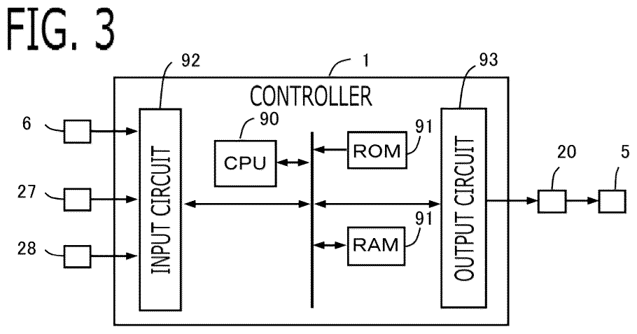

The controller 1 controls the AC rotary electric machine 5 via the inverter 20. As shown in FIG. 2, the controller 1 is provided with a rotation detection unit 31, a voltage command calculation unit 32, a PWM control unit 33, a period change unit 34, and the like. Each function of the controller 1 is realized by processing circuits provided in the controller 1. Specifically, as shown in FIG. 3, the controller 1 is provided with, as a processing circuit, an arithmetic processor (computer) 90 such as a CPU (Central Processing Unit), storage apparatuses 91 which exchange data with the arithmetic processor 90, an input circuit 92 which inputs external signals to the arithmetic processor 90, an output circuit 93 which outputs signals from the arithmetic processor 90 to the outside, and the like.

As the arithmetic processor 90, ASIC (Application Specific Integrated Circuit), IC (Integrated Circuit), DSP (Digital Signal Processor), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed. As the storage apparatuses 91, a RAM (Random Access Memory) which can read data and write data from the arithmetic processor 90, a ROM (Read Only Memory) which can read data from the arithmetic processor 90, and the like are provided. The input circuit 92 is connected with various kinds of sensors and switches such as the voltage sensor 27, the current sensor 28, and the rotation sensor 6, and is provided with A/D converter and the like for inputting output signals from the sensors and the switches to the arithmetic processor 90. The output circuit 93 is connected with electric loads, such as a gate drive circuit which drive on/off the switching devices, and is provided with a driving circuit and the like for outputting a control signal from the arithmetic processor 90.

Then, the arithmetic processor 90 runs software items (programs) stored in the storage apparatus 91 such as ROM and collaborates with other hardware devices in the controller 1, such as the storage apparatus 91, the input circuit 92, and the output circuit 93, so that the respective functions of the control units 31 to 34 in FIG. 2 provided in the controller 1 are realized. Setting data, such as the carrier period Tca and the update period Tup, utilized in the control units 31 to 34 is stored in the storage apparatus 91, such as ROM. Each function of the controller 1 will be described in detail below.

### <Rotation Detection Unit 31>

The rotation detection unit 31 detects a magnetic pole position θ (a rotational angle θ of the rotor) in an electrical angle and a rotational angle speed ω of the rotor. In the present embodiment, the rotation detection unit 31 detects the magnetic pole position θ (rotational angle θ) and the rotational angle speed ω of the rotor based on the output signal of the rotation sensor 6. In the present embodiment, the magnetic pole position is set to a direction of the N pole of the rotor. The rotation detection unit 31 may estimate the rotational angle (the magnetic pole position) without using the rotation sensor, based on current information which are obtained by superimposing a harmonic wave component on the current command value (so-called, sensorless system).

### <Voltage Command Calculation Unit 32>

The voltage command calculation unit 32 calculates and updates AC voltage command values of three-phase Vuo, Vvo, Vwo applied to the three-phase windings at an update period Tup. The AC voltage command values of three-phase Vuo, Vvo, Vwo vibrate at the AC period TAC. Each processing of the voltage command calculation unit 32 is executed at every update period Tup.

As described below in detail, the update period Tup is set to a value obtained by dividing the carrier period Tca by n (n is a natural number) (Tup=Tca/n). The natural number is an integer greater than or equal to 1.

The voltage command calculation unit 32 calculates the AC voltage command values of three-phase using well-known vector control. The voltage command calculation unit 32 calculates current command values of d-axis and q-axis Ido, Iqo, based on a torque command value To, the rotational angle speed ω, and the DC voltage VDC detected by the voltage sensor 27, and the like. The voltage command calculation unit 32 converts current detection values of three-phase windings Iur, Ivr, Iwr detected by the current sensor 28 into the current detection values of d-axis and q-axis Idr, Iqr, based on the magnetic pole position θ. Then, the voltage command calculation unit 32 changes voltage command values of d-axis and q-axis Vdo, Vqo by PI control and the like so that the current detection values of d-axis and q-axis Idr, Iqr approach the current command values of d-axis and q-axis Ido, Iqo, respectively. The voltage command calculation unit 32 converts the voltage command values of d-axis and q-axis Vdo, Vqo into the AC voltage command values of three-phase Vuo, Vvo, Vwo, based on the magnetic pole position θ. The well-known modulation for reducing amplitude, such as two-phase modulation and third order harmonic wave superposition, may be added to the AC voltage command values of three-phase Vuo, Vvo, Vwo. The present embodiment explains a case where the modulation is not added.

### <PWM Control Unit 33>

The PWM control unit 33 generates a carrier signal CA which has an amplitude according to the DC voltage VDC supplied to the inverter 20, and vibrates at a carrier period Tca; and controls on/off the plurality of switching devices of the inverter 20, based on a comparison result between each of the AC voltage command values of three-phase Vuo, Vvo, Vwo, and the carrier signal CA.

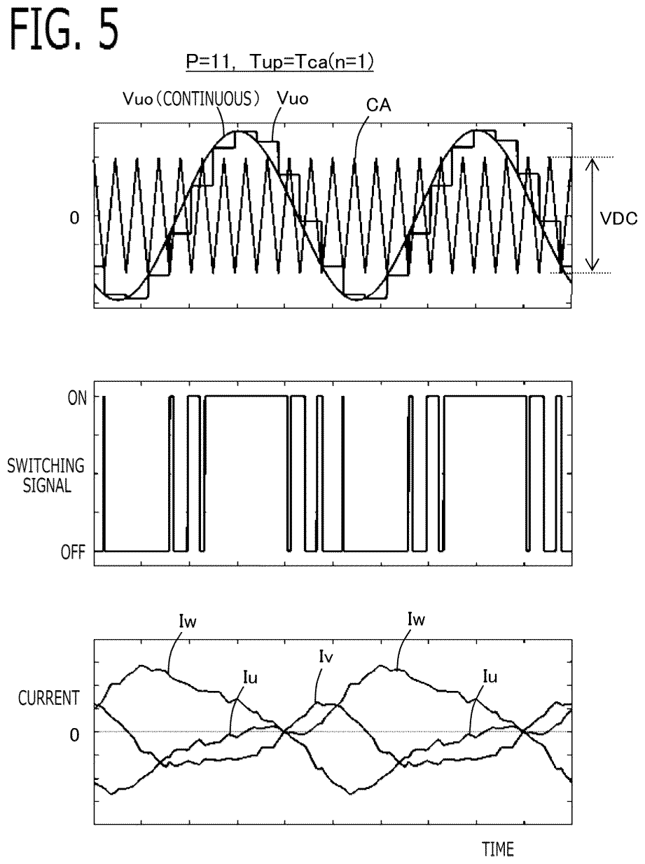

As shown in FIG. 5, in the present embodiment, the PWM control unit 33 generates the carrier signal CA which vibrates at the carrier period Tca with an amplitude of half value VDC/2 of the DC voltage centering on a vibration center value (in this example, 0) of the AC voltage command values of three-phase. The carrier signal CA is a triangular wave.

For each phase, the voltage command calculation unit 32 turns on the switching signal when the AC voltage command value exceeds the carrier signal CA, and turns off the switching signal when the AC voltage command value is less than the carrier signal. The switching signal is transmitted to the high potential side switching device as it is, and a switching signal obtained by inverting the switching signal is transmitted to the low potential side switching device. Each switching signal is inputted into the gate terminal of each switching device of the inverter 20 via the gate drive circuit, and each switching device is turned on or turned off.

### <Period Change Unit 34>

The period change unit 34 changes one or both of the carrier period Tca and the update period Tup. The changed carrier period Tca is transmitted to the PWM control unit 33, and is reflected in the generation of the carrier signal CA. The changed update period Tup is transmitted to the voltage command calculation unit 32, and is reflected in the calculation of the AC voltage command values.

### <Increase in Low Frequency Components at Specific Carrier Signal Numbers P>

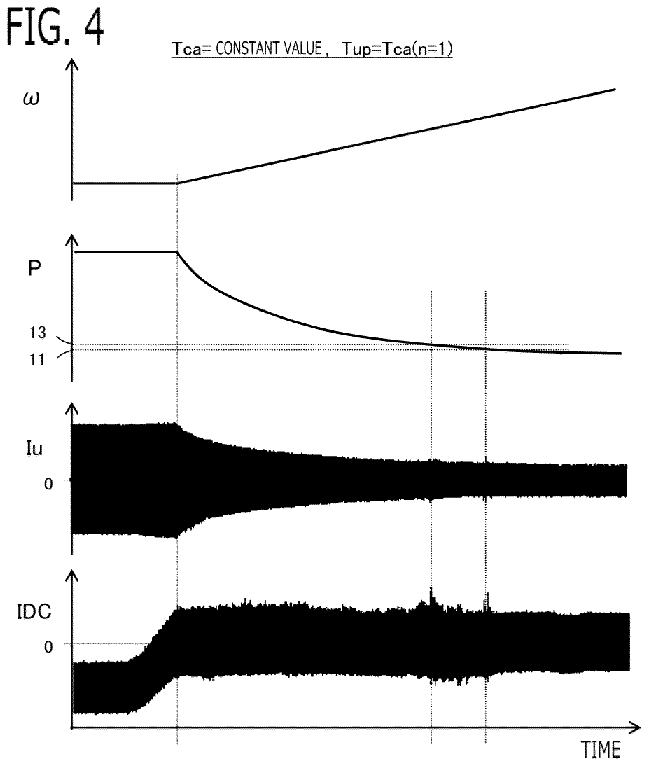

The principle of period change will be explained below. First, FIG. 4 shows the control behavior of a comparative example in which the period change is not performed. The carrier period Tca is set to a constant value, and the update period Tup is set to the carrier period Tca (n=1). The rotational angle speed ω is swept from the low speed to the high speed. At each rotational angle speed ω, it is in an overmodulation state where the vibration range of the AC voltage command value exceeds the vibration range of the carrier signal CA. FIG. 4 shows a change in the carrier signal number P (=TAC/Tca) which is a value obtained by dividing the AC period TAC of the AC voltage command values by the carrier period Tca. Since the AC period TAC is 2n/ω and is inversely proportional to the rotational angle speed ω, the carrier signal number P decreases as the rotational angle speed ω increases. FIG. 4 shows a phase current flowing into the winding of each phase, and a DC current IDC flowing between the DC power source 10 and the inverter 20.

When the carrier signal number P is 13 and 11, pulsation occurs in the phase current and the DC current IDC.

Next, FIG. 5 shows the expanded control behavior when the carrier signal number P is 11. In FIG. 5, similar to FIG. 4, the update period Tup is set to the carrier period Tca (n=1).

FIG. 5 shows the AC voltage command value Vuo of U phase. The AC voltage command value Vuo of U phase is calculated and updated at every carrier period Tca. For easy understanding, FIG. 5 shows the AC voltage command value Vuo of U phase when it is calculated continuously. The vibration range of the AC voltage command value Vuo of U phase exceeds the vibration range of the carrier signal CA, and it is in the overmodulation state.

The switching signal is generated based on the comparison result between the AC voltage command value Vuo of U phase updated at every update period Tup (carrier period Tca) and the carrier signal CA, as mentioned above. Since it is in the overmodulation state, the number of turning on and off of the switching signal decreases.

The phase current Iu, Iv, Iw of each phase is offset. As a result, the variation of the DC current IDC also becomes large.

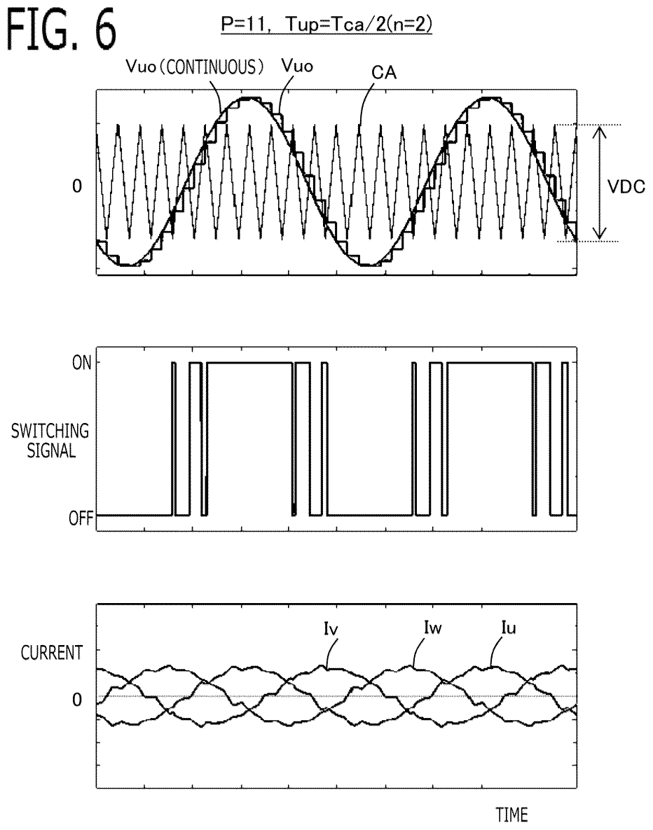

FIG. 6 shows the control behavior under the operating condition similar to FIG. 5. Unlike FIG. 4 and FIG. 5, in FIG. 6, the update period Tup is set to a half period Tca/2 of the carrier period (n=2). Accordingly, the update period Tup of the AC voltage command value Vuo of U phase is a half of FIG. 5. On the other hand, similar to FIG. 5, since it is in the overmodulation state, the number of turning on and off of the switching signal decreases.

However, unlike FIG. 5, the offset of the phase current Iu, Iv, Iw of each phase does not occur. The variation of the DC current IDC does not become large, either.

Therefore, even when the carrier signal number P is the same number, it can be seen that the presence or absence of the offset change of the phase current changes depending on the setting values of the update period Tup.

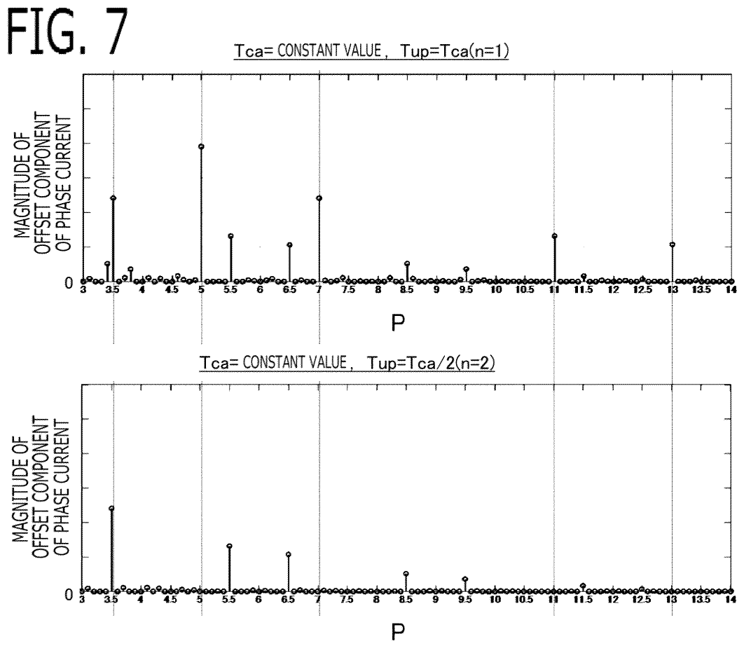

The upper stage of FIG. 7 shows a magnitude of the offset component of the phase current at each carrier signal number P (=TAC/Tca) which is set by changing the AC period TAC (rotational angle speed ω), when the carrier period Tca is set to a constant value, the update period Tup is set to the carrier period Tca (n=1), and it is in the overmodulation state. The lower stage of FIG. 7 shows the magnitude of the offset component of the phase current at each carrier signal number P (=TAC/Tca) which is set by changing the AC period TAC (rotational angle speed ω)), when the carrier period Tca is set to the same value as the upper stage of FIG. 7, the update period Tup is set to the half period Tca/2 of the carrier period (n=2) and it is in the same overmodulation state.

In the upper stage of FIG. 7, when the carrier signal number P is 13, 11.5, 11, 9.5, 8.5, 7, 6.5, 5.5, 5, 3.5, and the like, the offset component of the phase current increases. 11 and 13 of the carrier signal number P coincide with the result when the rotational angle speed ω is swept shown in FIG. 4.

In the lower stage of FIG. 7, when the carrier signal number P is 11.5, 9.5, 8.5, 6.5, 5.5, 3.5, and the like, the offset component of the phase current increases. Compared with the upper stage of FIG. 7, the offset component does not increase at P=13, 11, 7, 5, but, other trends are similar. Also for voltage and power supplied to three-phase windings other than the phase current, the amplitude of the low frequency components with respect to the AC frequency increases. Not limited to the offset component, the amplitude of the low frequency components with respect to the AC frequency increases in current, voltage, and power.

Herein, if it is assumed that the AC voltage command value of each phase is an ideal sine wave, the AC voltage command value Vo of each phase updated at the update period Tup can be expressed like the next equation.

$$[ Math . 1 ]$$

$$\begin{matrix}Vo ( j ) = A \times sin ( \frac{2 π}{{T}_{AC}} \times j \times {T}_{up} + δ + Δ ) \\ = A \times sin ( \frac{2 π}{n \times P} \times j + δ + Δ ) \\ = A \times sin ( \frac{2 π \times K}{n \times P \times K} \times j + δ + Δ ) \\ P = \frac{{T}_{AC}}{{T}_{ca}} , {T}_{up} = \frac{{T}_{ca}}{n}\end{matrix} \qquad ( 1 )$$

Herein, j is a number of the update period Tup and increases one by one. Δ is a phase difference between a bottom phase of the carrier signal and a phase of the ideal sine wave, Δ is a phase of each phase, Δ of U phase is 0, Δ of V phase is 2n/3, and Δ of W phase is 4n/3. A is an amplitude of the AC voltage command value. K is a coefficient for evaluation which is set to the smallest natural number with which n×P×K becomes a natural number.

From the first equation of the equation (1), it can be seen that K times value (2π×K) which is a natural number times value of the AC period TAC is divided by n×P×K which is the smallest natural number, and a sin value and the AC voltage command value Vo are calculated and updated for each divided period. In the overmodulation state, an average value of the applied voltage in each divided period after the carrier comparison becomes +VDC/2 or −VDC/2 at the maximum due to the voltage saturation. Accordingly, when the division number n×P×K is an odd number, a balance between a period of +VDC/2 and a period of −VDC/2 becomes unbalance by one divided period. Accordingly, a total value of the applied voltage of each phase during the period of TAC×K shifts from 0 by ±VDC/2×(TAC×K/(n×P×K)) at the maximum. Accordingly, in the overmodulation state, as shown in the next equation, the average value Vave of the applied voltage of each phase is shifted by ±VDC/2/(n×P×K) at the maximum. Accordingly, in the overmodulation state, when n×P×K is an odd number, the average value Vave of the applied voltage of each phase shifts from 0, and a shift amount of the average value Vave of the applied voltage of each phase is inversely proportional to n×P×K.

$$[ Math . 2 ]$$

$$\begin{matrix}{V}_{ave} = \frac{\pm {V}_{DC}}{2} \frac{{T}_{AC} \times K}{n \times P \times K} \frac{1}{{T}_{AC} \times K} \\ = \frac{\pm {V}_{DC}}{2} \frac{1}{n \times P \times K}\end{matrix} \qquad ( 2 )$$

On the other hand, even when n×P×K is an odd number and a multiple of 3, the shift of the applied voltage of each phase of U phase, V phase, and W phase has a phase difference of 2π/3 mutually, and the shift is mutually canceled by the three-phase equilibrium, and the phase current of each phase does not offset. Accordingly, in the overmodulation state, when n×P×K is an odd number and a number other than the multiple of 3, an offset of the phase current and the like and the increase in the low frequency components occur. Since the shift amount of the average value Vave of the applied voltage of each phase is inversely proportional to n×P×K, when n×P×K is large, the shift amount of the average value Vave of the applied voltage of each phase becomes small, and the offset amount of phase current becomes small.

That is, in the overmodulation state, when the evaluation value N calculated by n×P×K shown in the next equation is an odd number and is a number other than the multiple of 3, components of frequencies lower than the AC period TAC increases in one or more of the current, voltage, and power supplied to the three-phase windings.

$$[ Math . 3 ]$$

$$\begin{matrix}N = n \times P \times K \\ P = \frac{{T}_{AC}}{{T}_{ca}} , {T}_{up} = \frac{{T}_{ca}}{n}\end{matrix} \qquad ( 3 )$$

Herein, the coefficient for evaluation K is set to the smallest natural number with which the evaluation value N (=n×P×K) becomes a natural number as mentioned above. As n×P×K becomes large, an increase amount of the low frequency components decreases.

Since n is 1 in the case of the upper stage of FIG. 7, P=13, 11.5, 11, 9.5, 8.5, 7, 6.5, 5.5, 5, 3.5 at which the offset component of the phase current increases comparatively large are K=1, 2, 1, 1, 2, 2, 1, 2, 2, 1, and become N=13, 23, 11, 19, 17, 7, 13, 11, 5, 7, respectively. Accordingly, each evaluation value N is an odd number and a number other than the multiple of 3. Among these, the increase amounts of the offset components of P=13, 11, 7, 5 at which K is 1 and N is small become comparatively large. On the other hand, the increase amounts of the offset components of P=11.5, 9.5, 8.5, 6.5, 5.5, 3.5 at which K is 2 and N is large become small. In addition to the carrier signal numbers P explained here, there are the carrier signal numbers P at which the evaluation value N is an odd number and a number other than the multiple of 3. But, since the evaluation value N becomes large and the increase amount of the offset component becomes small, the explanation is omitted.

In the case of the lower stage of FIG. 7, since n is 2, P=9.5, 8.5, 6.5, 5.5, 3.5 at which the offset component of the phase current increases comparatively large are K=1, 1, 1, 1, 1, and become N=19, 17, 13, 11, 7, respectively. Accordingly, each evaluation value N is an odd number and a number other than the multiple of 3. On the other hand, since P=13, 11, 7, 5 at which the increase amount of the offset component is large in the upper stage of n=1 become even numbers of N=26, 22, 14, 10 in the lower stage of n=2, the offset component does not increase. In addition to the carrier signal numbers P explained here, there are the carrier signal numbers P at which the evaluation value N is an odd number and a number other than the multiple of 3. But, since the evaluation value N becomes large and the increase amount of the offset component becomes small, the explanation is omitted.

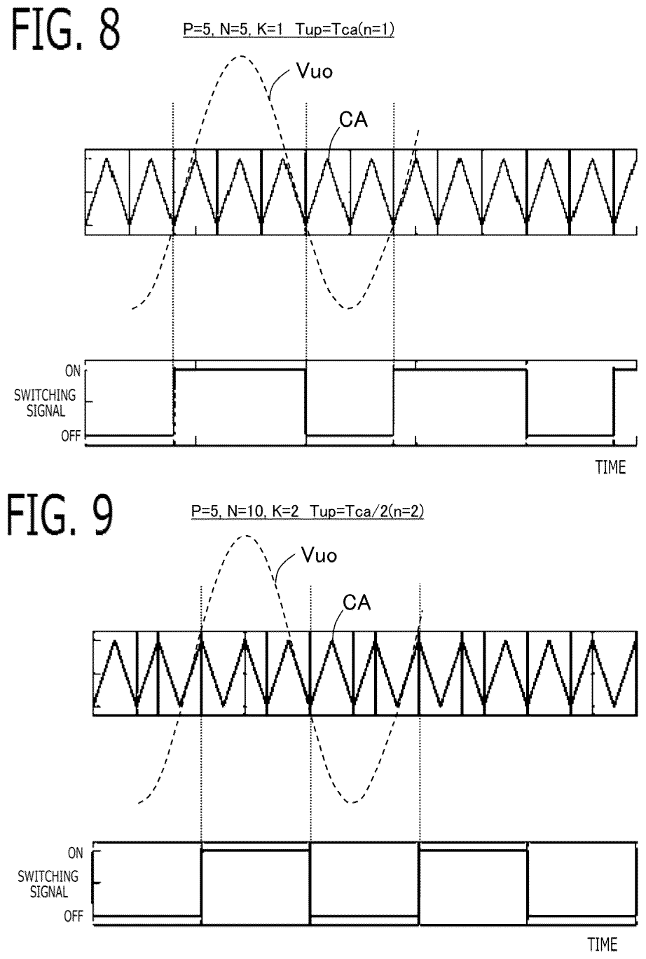

FIG. 8 shows the control behavior when it is in the overmodulation state close to the maximum, the carrier signal number P is 5, the update period Tup is set to the carrier period Tca (n=1), the coefficient for evaluation K becomes 1, and the evaluation value N (=n×P×K) becomes 5. The evaluation value N=5 is an odd number and a number other than the multiple of 3. As explained using the equation (1), the AC period TAC×1 is divided by the evaluation value N=5, and the sin value and the AC voltage command value Vo are calculated for each divided period. But, since it is in the overmodulation state close to the maximum, the average value of the applied voltage in each divided period becomes +VDC/2 or −VDC/2. Since the division number is an odd number of 5, a balance between a period of +VDC/2 and a period of −VDC/2 becomes unbalance by one divided period. In FIG. 8, the on period of the switching signal of U phase becomes longer than the off period by one divided period. As the result, the shift amount of the average value Vave of the applied voltage of U phase becomes VDC/2/5, and the average value of the phase current of U phase winding shifts to the positive side.

FIG. 9 shows the control behavior when it is in the overmodulation state close to the maximum, the carrier signal number P is 5, the update period Tup is set to a half period Tca/2 of the carrier period (n=2), the coefficient for evaluation K becomes 1, and the evaluation value N (=n×P×K) becomes 10. The evaluation value N=10 is an even number. As explained using the equation (1), the AC period TAC×1 is divided by the evaluation value N=10, and the sin value and the AC voltage command value Vo are calculated for each divided period. But, since it is in the overmodulation state close to the maximum, the average value of the applied voltage in each divided period becomes +VDC/2 or −VDC/2. Since the division number is an even number of 10, the period of +VDC/2 and the period of −VDC/2 become equal. In FIG. 9, the on period and the off period of the switching signal of U phase become equal. As the result, the average value Vave of the applied voltage of U phase does not shift from 0, and the average value of the phase current of U phase winding does not shift.

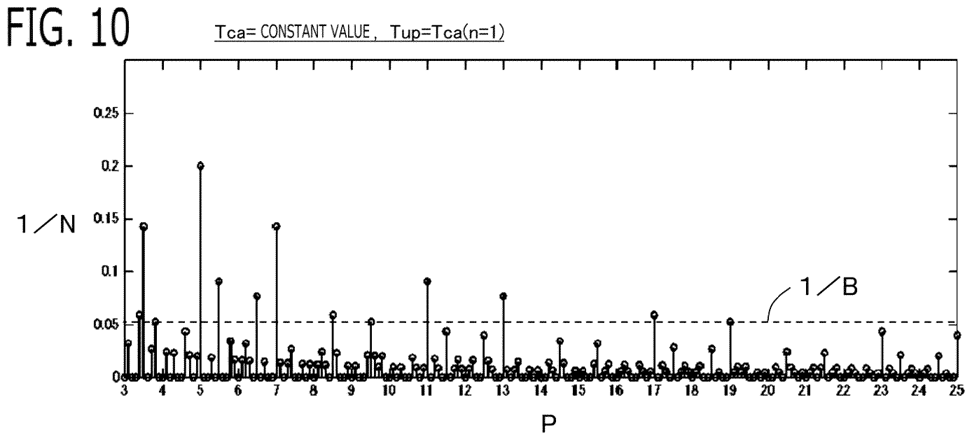

FIG. 10 shows the graph corresponding to the upper stage of FIG. 7. But, the vertical axis is changed to 1/N which correlates to the increase amount of the low frequency components. Even when the evaluation value N is an odd number and a number other than the multiple of 3, when the evaluation value N is large, 1/N becomes small. 1/N generally correlates with the increase amount of the offset component in the upper stage of FIG. 7. A threshold line where 1/N becomes 1/B is drawn in FIG. 10. In order to suppress the increase in the low frequency components effectively, it is good to set n and Tca so that 1/N may not become the evaluation value N which becomes larger than 1/B. n and Tca may be set so as not to become the evaluation value N with which 1/N becomes larger than 1/B. In the example of FIG. 10, 1/N becomes larger than 1/B at P=13, 11, 7, 6.5, 5.5, 5, 3.5 and the like.

### <Period Change Unit 34>

Then, the period change unit 34 changes one or both of the carrier period Tca and the update period Tup so that the evaluation value N does not coincide with a specific value at which components of frequencies lower than the AC period TAC increases in one or more of current, voltage, and power supplied to the plural-phase windings. The evaluation value N is calculated based on a carrier signal number which is a value obtained by dividing the AC period TAC of the AC voltage command values by the carrier period Tca, and the update period Tup.

According to this configuration, since the low frequency components increase when the evaluation value N coincides with the specific value, the low frequency components can be suppressed from increasing, by changing one or both of the carrier period Tca and the update period Tup so that the evaluation value N does not coincide with the specific value.

In the present embodiment, the evaluation value N is a value calculated by the above equation (2), and the coefficient for evaluation K is set to the smallest natural number with which the evaluation value N becomes a natural number. Then, the specific value is set to the evaluation value N which is an odd number and a value other than a multiple of 3. One or a plurality of specific values are set.

According to this configuration, as explained using the equation (1) and the equation (2), a K times value (2π×K) of the AC period TAC is divided by the evaluation value N (=n×P×K) which is the smallest natural number, and the AC voltage command value Vo of each phase is calculated and updated for each divided period. In the overmodulation state, an average value of the applied voltage in each divided period after the carrier comparison becomes +VDC/2 or −VDC/2 at the maximum due to the voltage saturation. Accordingly, when the evaluation value N is an odd number, a balance between the period of +VDC/2 and the period of −VDC/2 becomes unbalanced by one divided period. Accordingly, a total value of the applied voltage of each phase during the period of TAC×K shifts from 0 by ±VDC/2×(TAC×K/(n×P×K)) at the maximum. Accordingly, the average value Vave of the applied voltage of each phase shifts by ±VDC/2/(n×P×K) at the maximum. On the other hand, even when the evaluation value N is an odd number, but is a multiple of 3, the shift amount of each phase of U phase, V phase, and W phase have a phase difference of 2π/3 mutually, and is mutually canceled by the three-phase equilibrium, and the phase current of each phase does not offset. Accordingly, when the evaluation value N is an odd number and a value other than the multiple of 3, the increase in the low frequency components occurs. Accordingly, by setting the specific value to the evaluation value N which is an odd number and a value other than the multiple of 3, and changing one or both of the carrier period Tca and the update period Tup so that the evaluation value N does not coincide with the specific value, the low frequency components can be suppressed from increasing.

In the present embodiment, the specific value is set to the evaluation value N which is an odd number, a value other than a multiple of 3, and less than or equal to a threshold value B.

According to this configuration, as explained using FIG. 7 and FIG. 10, there is a correlation between 1/N and the increase amount of the low frequency components, if 1/N becomes greater than or equal to 1/B, that is, the specific value is set to the evaluation value N which is less than or equal to B, the specific value is set to the evaluation value N which requires the suppression of the increase in the low frequency components, and the increase in the low frequency components can be suppressed effectively. For example, B is set to 17.

For example, in the example of FIG. 10, the specific value may be set to one or more of N=13, 11, 7, 13, 11, 5, 7 corresponding to P=13, 11, 7, 6.5, 5.5, 5, 3.5 respectively, that is, N=13, 11, 7, 5.

The specific value may be set to the evaluation value N with which the increase amount of the low frequency components becomes greater than or equal to a threshold value. Alternatively, the specific value may be set to the evaluation value N with which the increase in the low frequency components becomes a problem.

In the present embodiment, when it is in the overmodulation state where the vibration range of the AC voltage command value Vo exceeds the vibration range of the carrier signal CA, the period change unit 34 changes one or both of the carrier period Tca and the update period Tup so that the evaluation value N does not coincide with the specific value.

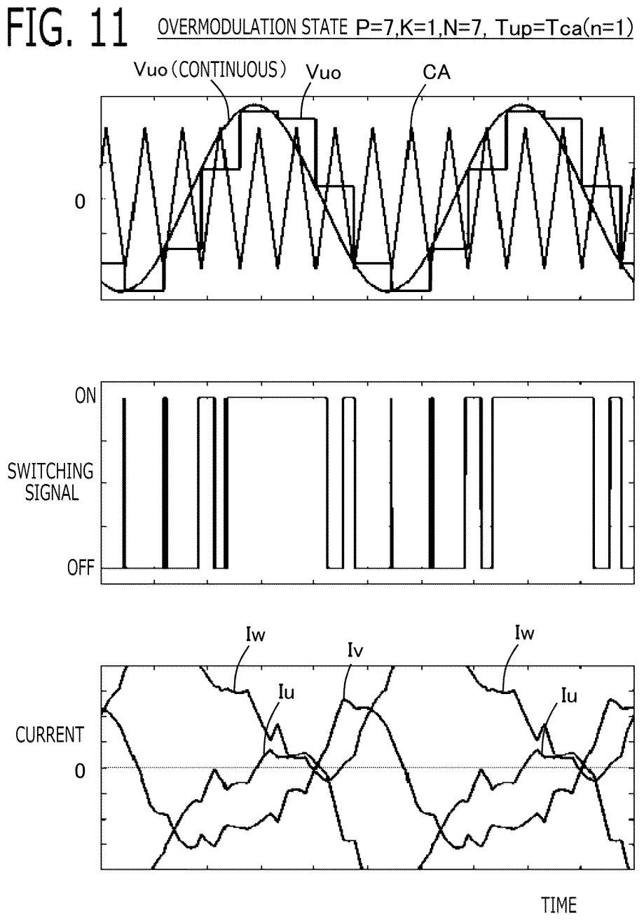

FIG. 11 shows the control behavior in the overmodulation state at n=1, P=7, and N=7. In the overmodulation state, the number of on/off times of the switching signal becomes less than the carrier signal number due to the voltage saturation, the continuous on period and the continuous off period become long, and an unbalance between the on period and the off period of the switching signal easily occurs. As a result, the shift of the phase current of each phase easily occurs.

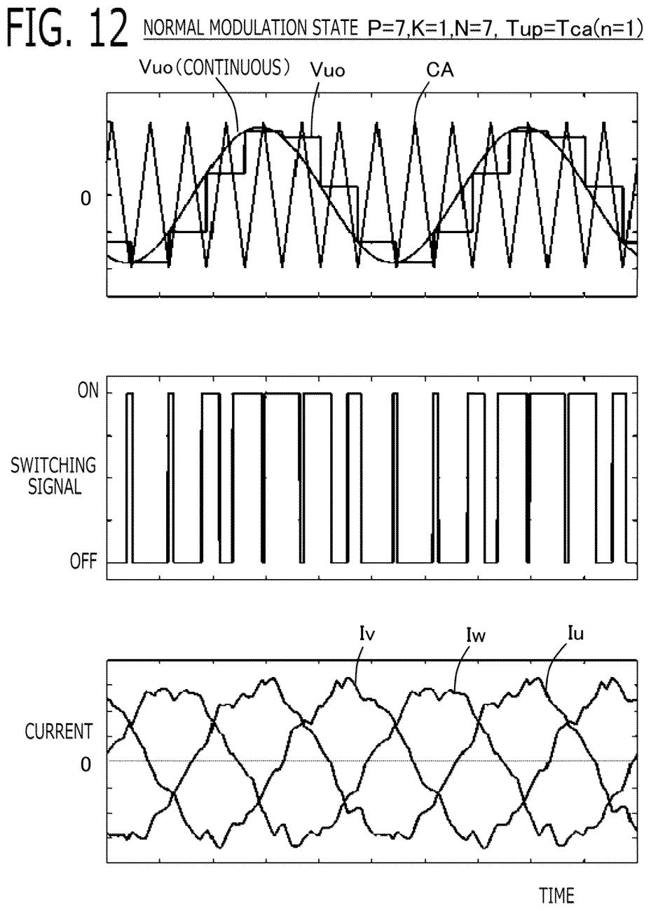

On the other hand, FIG. 12 shows the control behavior not in the overmodulation state at n=1, P=7, and N=7. When not in the overmodulation state, the number of on/off times of the switching signal does not decrease with respect to the carrier signal number, the continuous on period and the continuous off period do not become long, and the unbalance between the on period and the off period of the switching signal hardly occurs. As a result, the shift of the phase current of each phase hardly occurs. Therefore, when in the overmodulation state, the increase in the low frequency components can be effectively suppressed by performing the period change. Also when not in the overmodulation state, the period change unit 34 may change one or both of the carrier period Tca and the update period Tup so that the evaluation value N does not coincide with the specific value.

In the present embodiment, the period change unit 34 determines whether or not it is the overmodulation state, based on a modulation rate M which is a ratio of the line voltage of the AC voltage command values of three-phase with respect to the DC voltage VDC. The period change unit 34 calculates the modulation rate M, based on the voltage command values of d-axis and q-axis Vdo, Vqo, and the DC voltage VDC, using the next equation.

$$[ Math . 4 ]$$

$$M = \frac{\sqrt{{V}_{do}^{2} + {V}_{qo}^{2}}}{{V}_{DC}} \sqrt{2} \qquad ( 4 )$$

In the present embodiment, the period change unit 34 determines that it is the overmodulation state, when the modulation rate M is one or more, and determines that it is not the overmodulation state (normal modulation), when the modulation rate M is less than one. The threshold value may be increased or decreased from 1 considering the increase amount of the low frequency components, and the like.

When the well-known modulation for reducing the amplitude, such as the two-phase modulation and the third order harmonic wave superposition, is added to the AC voltage command values of three-phase Vuo, Vvo, Vwo, the period change unit 34 determines that it is the overmodulation state, when the modulation rate M is 1.15 or more, and determines that it is not the overmodulation state, when the modulation rate M is less than 1.15. Also in this case, the threshold value may be increased or decreased from 1.15.

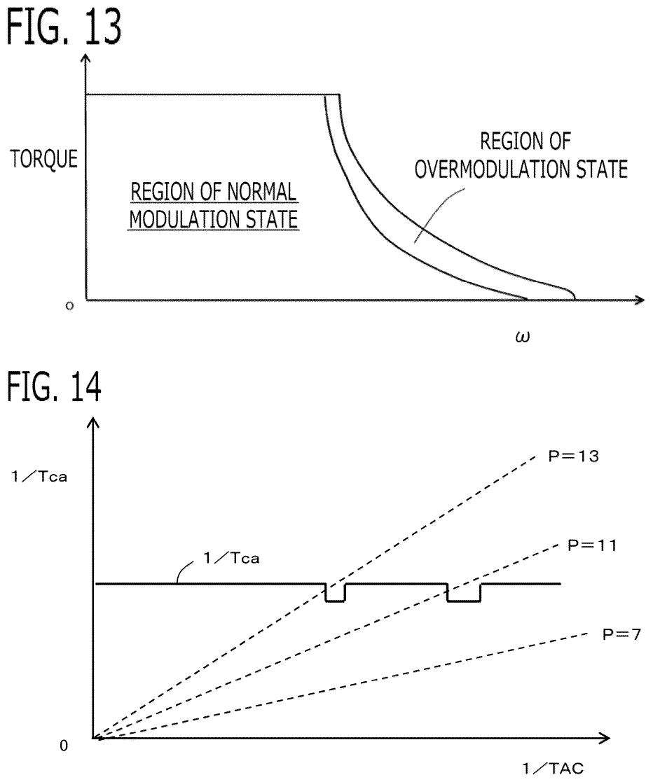

For example, a region of the overmodulation state and a region of the normal modulation state are shown in FIG. 13. The overmodulation state exists in a region of high rotational angle speed and high torque.

### <Period Change Based on AC Period TAC>

The period change unit 34 changes one or both of the carrier period Tca and the update period Tup based on the AC period TAC so that the evaluation value N does not coincide with the specific value. Instead of the AC period TAC, the AC frequency 1/TAC or the rotational angle speed ω may be used.

As shown in the equation (3), the carrier signal number P correlating with the evaluation value N changes according to the AC period TAC. Accordingly, based on the AC period TAC, it can be grasped whether or not the evaluation value N coincides with the specific value when one or both of the carrier period Tca and the update period Tup are not changed. Then, based on the AC period TAC, one or both of the carrier period Tca and the update period Tup can be accurately changed so that the evaluation value N does not coincide with the specific value.

For example, by referring to a map data in which a relation between the AC period TAC, and one or both of the setting value of the carrier period Tca and the setting value of the update period Tup with which the evaluation value N does not coincide with the specific value is preliminarily set, the period change unit 34 calculates and sets one or both of the setting value of the carrier period Tca and the setting value of the update period Tup corresponding to the present AC period TAC. Instead of the carrier period Tca, the carrier frequency 1/Tca may be set.

### <When Changing Carrier Period Tca>

For example, as explained using FIG. 10, when the update period Tup is set to the carrier period Tca (n=1), for example, the evaluation values N=13, 11, 7 corresponding to the carrier signal numbers P=13, 11, 7 may be set as the specific values. FIG. 14 shows lines where the carrier signal number P coincides with 13, 11, 7, and an example of the setting value of the carrier frequency 1/Tca, when the horizontal axis is set to the AC frequency 1/TAC, and the vertical axis is set to the carrier frequency 1/Tca.

As shown in FIG. 14, the carrier frequency 1/Tca is changed based on the AC frequency 1/TAC so as to avoid the carrier signal numbers P=13, 11, 7 corresponding to the specific values 13, 11, 7. The map data in which the relation between the AC frequency 1/TAC and the setting value of the carrier frequency 1/Tca is set as shown in FIG. 14 is preliminarily set. In the example of FIG. 14, the carrier signal number P to be avoided is set to 13, 11, 7. But, the value of the carrier signal number P to be avoided may be changed according to the operating range of the AC frequency 1/TAC, the setting range of the carrier frequency 1/Tca, and the setting value of the update period Tup. The map data may be set so that the carrier frequency 1/Tca avoids one or a plurality of the carrier signal numbers P corresponding to one or a plurality of the specific values, and may be set to any value different from FIG. 14.

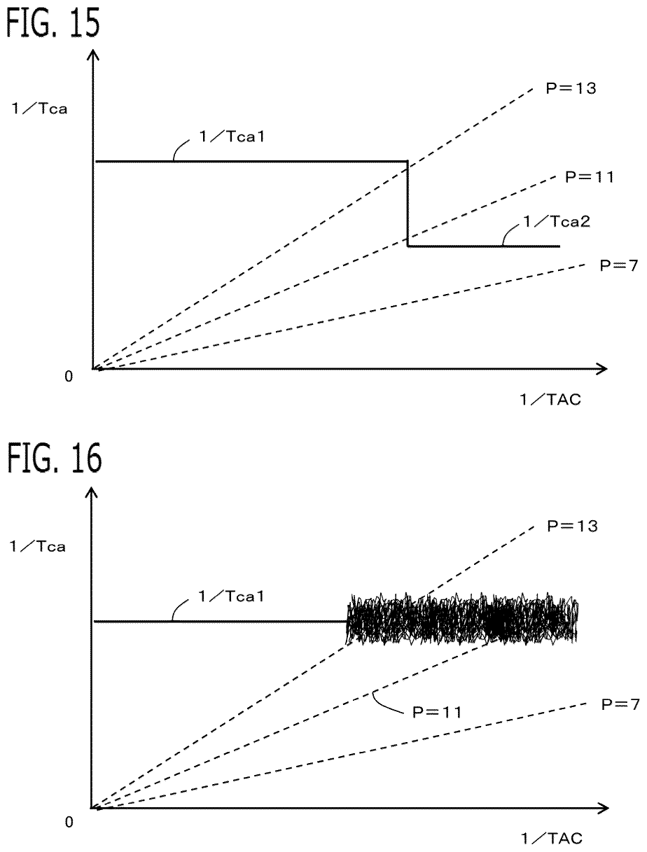

As shown in FIG. 15, under a specific condition where the evaluation value N approaches the specific value when the carrier period Tca is set to a preliminarily set first carrier period Tca1, the period change unit 34 may set the carrier period Tca to a second carrier period Tca2 which is preliminarily set so that the evaluation value N does not coincide with the specific value, and under other than the specific condition, the period change unit 34 may set the carrier period Tca to the first carrier period Tca1. In the case of FIG. 15, the update period Tup may be set to the carrier period Tca (n=1), and the evaluation values N=13, 11, 7 corresponding to the carrier signal numbers P=13, 11, 7 may be set as the specific values. In the example of FIG. 15, in a specific region of the AC frequency 1/TAC where the evaluation value N approaches the specific values 13 and 11 when the first carrier frequency 1/Tca1 is set, the carrier frequency 1/Tca is set to the second carrier frequency 1/Tca2. In the example of FIG. 15, the second carrier frequency 1/Tca2 is set to a frequency lower than the first carrier frequency 1/Tca1, but may be set to a higher frequency.

Alternatively, as shown in FIG. 16, under a specific condition where the evaluation value N approaches the specific value when the carrier period Tca is set to a preliminarily set first carrier period Tca1, the period change unit 34 may change the carrier period Tca at random, and under other than the specific condition, the period change unit 34 may set the carrier period Tca to the first carrier period Tca1. In the example of FIG. 16, in the specific region of the AC frequency 1/TAC where the evaluation value N approaches the specific values 13 and 11 when the first carrier frequency 1/Tca1 is set, the carrier frequency 1/Tca is changed at random. In the example of FIG. 16, the carrier frequency 1/Tca is changed at random within a predetermined range centering on the first carrier frequency 1/Tca1. By changing at random, a period when the evaluation value N coincides with the specific value can be shortened significantly.

In the example of FIG. 16, the one specific region of the AC frequency 1/TAC is set by combining the specific values 13 and 11, and the carrier frequency 1/Tca is changed at random. But, a specific region for the specific value 13 and a specific region for the specific value 11 may be set individually, and the carrier frequency 1/Tca may be changed at random in each specific region.

### <When Changing Update Period Tup>

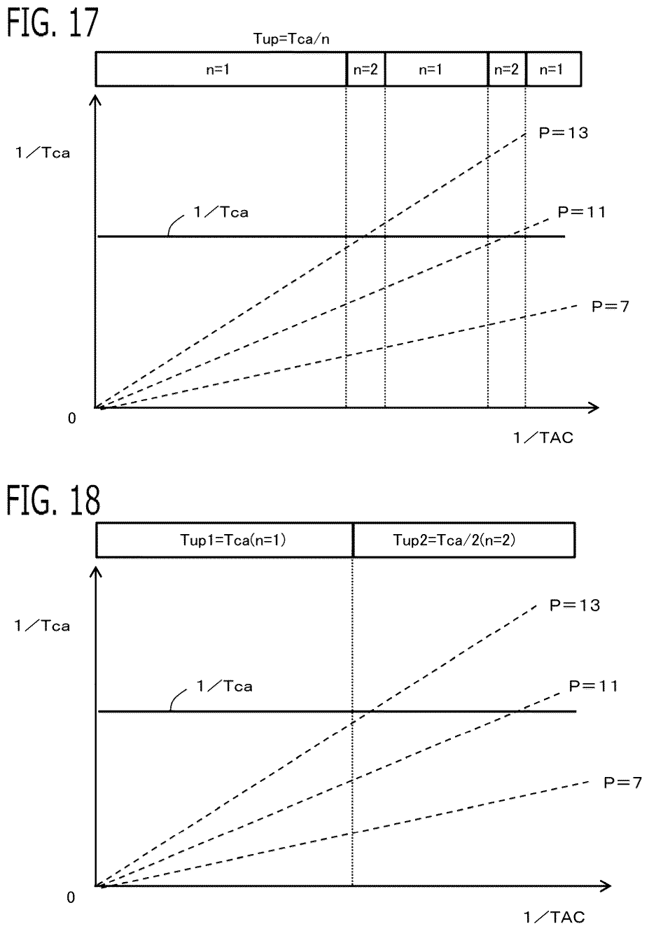

For example, when the update period Tup is set to the carrier period Tca (n=1), the evaluation values N=13, 11, 7 corresponding to the carrier signal number P=13, 11, 7 are set as the specific values. But, when the update period Tup is set to a half period Tca/2 (n=2) of the carrier period, there is no specific value to be set. That is, the specific value is changed according to the update period Tup. FIG. 17 shows lines where the carrier signal number P coincides with 13, 11, 7, and an example of the setting value of the carrier frequency 1/Tca, the horizontal axis is set to the AC frequency 1/TAC, and the vertical axis is set to the carrier frequency 1/Tca.

As shown in FIG. 17, the carrier frequency 1/Tca is set to a constant value. On the other hand, the update period Tup is changed based on the carrier period Tca so as to avoid the specific values 13, 11, 7 in the case of n=1. The map data in which the relation between the AC frequency 1/TAC and the setting value of the update period Tup (n) is set as shown in FIG. 17 is preliminarily set. In the example of FIG. 17, the carrier signal numbers P to be avoided in the case of n=1 are set to 13, 11, 7. But, the value of the carrier signal number P to be avoided may be changed according to the operating range of the AC frequency 1/TAC, the setting range of the carrier frequency 1/Tca, and the setting value of the update period Tup.

As shown in FIG. 18, under a specific condition where the evaluation value N approaches the specific value when the update period Tup is set to a preliminarily set first update period Tup1, the period change unit 34 sets the update period Tup to a second update period Tup2 which is preliminarily set so that the evaluation value N does not coincide with the specific value, and under other than the specific condition, the period change unit 34 sets the update period Tup to the first update period Tup1. In the case of FIG. 18, the first update period Tup1 is set to the carrier period Tca (n=1), and the second update period Tup2 is set to the half period Tca/2 (n=2) of the carrier period. The specific values of the first update period Tup1 are 13, 11, 7, and there is no specific value of the second update period Tup2. When the evaluation value N coincides with the specific values of the first update period Tup1, the specific values can be avoided by changing the update period Tup to the second update period Tup2. In the example of FIG. 18, in the specific region of the AC frequency 1/TAC where the evaluation value N approaches the specific values 13 and 11 when the first update period Tup1 is set, the update period Tup is set to the second update period Tup2.

The period change unit 34 may change the carrier period Tca and the update period Tup at the same time based on the AC period TAC so that the evaluation value N does not coincide with the specific value.

### 2. Embodiment 2

Next, the AC rotary electric machine 5 and the controller 1 according to Embodiment 2 will be explained. The explanation for constituent parts the same as those in Embodiment 1 will be omitted. The basic configuration of the AC rotary electric machine 5 and the controller 1 according to the present embodiment is the same as those of Embodiment 1. In the present embodiment, the PWM control unit 33 executes a synchronous PWM mode. Accordingly, the processing of the period change unit 34 is different from Embodiment 1.

In the present embodiment, the PWM control unit 33 executes a synchronous PWM mode in which the carrier period Tca is changed in proportion to the AC period TAC. In the synchronous PWM mode, the carrier frequency 1/Tca is set to a value obtained by multiplying a proportional coefficient Kp of a natural number to the AC frequency 1/TAC. The PWM control unit 33 can also execute an asynchronous PWM mode in which the carrier period Tca is changed not in proportion to the AC period TAC. For example, the PWM control unit 33 executes the asynchronous PWM mode, when the rotational angle speed ω is less than a switching value, and executes the synchronous PWM mode, when rotational angle speed ω is greater than or equal to the switching value.

When the synchronous PWM mode is executed, the period change unit 34 sets the proportional coefficient Kp so that the evaluation value N does not coincide with the specific value, and changes the carrier period Tca in proportion to the AC period TAC using the set proportional coefficient Kp.

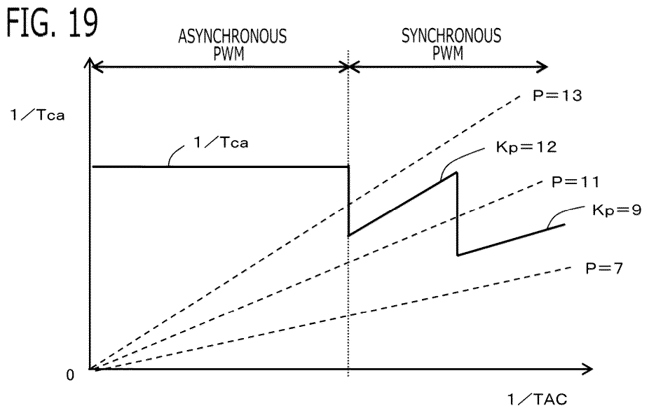

For example, as shown in FIG. 19, when the update period Tup is set to the carrier period Tca (n=1), for example, the evaluation values N=13, 11, 7 corresponding to the carrier signal numbers P=13, 11, 7 are set as the specific values. In the example of FIG. 19, in a region of the AC frequency 1/TAC (rotational angle speed ω) where the synchronous PWM mode is executed, the evaluation value N does not approach the specific values 13, 11, and 7. In a region of the AC frequency 1/TAC where the asynchronous PWM mode is executed, the evaluation value N approaches the specific values 13, 11, and 7.

The proportional coefficient Kp is changed based on the AC frequency 1/TAC so as to avoid the carrier signal numbers P=13, 11, 7 corresponding to the specific values 13, 11, 7. That is, the proportional coefficient Kp is set to a natural number other than the specific values 13, 11, 7. In the example of FIG. 19, the proportional coefficient Kp is set to 12 and 9. The map data in which the relation between the AC frequency 1/TAC and the setting value of the proportional coefficient Kp is set as shown in FIG. 19 is preliminarily set. In this way, by setting the proportional coefficient Kp so that the evaluation value N does not coincide with the specific value, the low frequency components can be suppressed from increasing.

In the execution region of the synchronous PWM mode, when the evaluation value N coincides with the specific value, the processing of Embodiment 1 may be executed.

### OTHER EMBODIMENTS

(1) In each of the above-mentioned Embodiments, there was explained the case where the three-phase windings is provided. However, as long as the phase number Q of windings is plural, it may be set to any number, such as two or four. In this case, the specific value may be set to the evaluation value N which is an odd number and a value other than a multiple of the phase number Q.
(2) In each of the above-mentioned embodiments, one set of three-phase windings is provided. However, a plural set of plural-phase windings may be provided. In this case, the processing of above each embodiment may be executed for each set of plural-phase windings.

### <Summary of Aspects of the Present Disclosure>

Hereinafter, the aspects of the present disclosure is summarized as appendixes.

### (Appendix 1)

A controller for an AC rotary electric machine that controls the AC rotary electric machine which is provided with plural-phase windings via an inverter, the controller for the AC rotary electric machine comprising:
a voltage command calculation unit that calculates and updates AC voltage command values of plural-phase applied to the plural-phase windings at an update period;
a PWM control unit that generates a carrier signal which has an amplitude according to a DC voltage supplied to the inverter and vibrates at a carrier period, and controls on/off a plurality of switching devices of the inverter, based on a comparison result between the carrier signal and each of the AC voltage command values of plural-phase; and
a period change unit that changes one or both of the carrier period and the update period,
wherein the period change unit changes one or both of the carrier period and the update period so that an evaluation value does not coincide with a specific value at which components of frequencies lower than an AC period increases in one or more of current, voltage, and power supplied to the plural-phase windings, and wherein the evaluation value is calculated based on a carrier signal number which is a value obtained by dividing the AC period of the AC voltage command values by the carrier period, and the update period.

### (Appendix 2)

The controller for the AC rotary electric machine according to appendix 1,
wherein, when it is in an overmodulation state where a vibration range of the AC voltage command values exceeds a vibration range of the carrier signal, the period change unit changes one or both of the carrier period and the update period so that the evaluation value does not coincide with the specific value.

### (Appendix 3)

The controller for the AC rotary electric machine according to appendix 1 or 2,
wherein the update period is set to a value obtained by dividing the carrier period by n (n is a natural number).

### (Appendix 4)

The controller for the AC rotary electric machine according to appendix 3,
wherein a phase number of the plural-phase windings is Q,
when the evaluation value is defined as N, the carrier signal number is defined as P and a coefficient for evaluation set to a natural number is defined as K, the evaluation value is a value calculated by an equation of “N=n×P×K”, and the coefficient for evaluation is set to a smallest natural number with which the evaluation value becomes a natural number,
the specific value is set to the evaluation value which is an odd number and a value other than a multiple of Q.

### (Appendix 5)

The controller for the AC rotary electric machine according to appendix 4,
wherein the specific value is set to the evaluation value which is an odd number, a value other than a multiple of Q, and a value less than or equal to a threshold value.

### (Appendix 6)

The controller for the AC rotary electric machine according to any one of appendixes 1 to 5,
wherein the period change unit changes one or both of the carrier period and the update period based on the AC period so that the evaluation value does not coincide with the specific value.

### (Appendix 7)

The controller for the AC rotary electric machine according to appendix 6,
wherein, by referring a map data in which a relation between the AC period, and one or both of a setting value of the carrier period and a setting value of the update period with which the evaluation value does not coincide with the specific value is preliminarily set, the period change unit calculates and sets one or both of the setting value of the carrier period and the setting value of the update period corresponding to the present AC period.

### (Appendix 8)

The controller for the AC rotary electric machine according to any one of appendixes 1 to 5,
wherein, under a specific condition where the evaluation value approaches the specific value when the carrier period is set to a preliminarily set first carrier period, the period change unit sets the carrier period to a second carrier period which is preliminarily set so that the evaluation value does not coincide with the specific value, and
under other than the specific condition, the period change unit sets the carrier period to the first carrier period.

### (Appendix 9)

The controller for the AC rotary electric machine according to any one of appendixes 1 to 5,
wherein, under a specific condition where the evaluation value approaches the specific value when the carrier period is set to a preliminarily set first carrier period, the period change unit changes the carrier period at random, and
under other than the specific condition, the period change unit sets the carrier period to the first carrier period.

### (Appendix 10)

The controller for the AC rotary electric machine according to any one of appendixes 1 to 7,
wherein the PWM control unit executes a synchronous PWM mode in which the carrier period is changed in proportion to the AC period, and
when the synchronous PWM mode is executed, the period change unit sets a proportional coefficient so that the evaluation value does not coincide with the specific value, and changes the carrier period in proportion to the AC period using the set proportional coefficient.

### (Appendix 11)

The controller for the AC rotary electric machine according to any one of appendixes 1 to 5,
wherein, under a specific condition where the evaluation value approaches the specific value when the update period is set to a preliminarily set first update period, the period change unit sets the update period to a second update period which is preliminarily set so that the evaluation value does not coincide with the specific value, and
under other than the specific condition, the period change unit sets the update period to the first update period.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1 Controller for AC Rotary Electric Machine, 5 AC Rotary Electric Machine, 20 Inverter, 32 Voltage Command Calculation Unit, 33 PWM Control Unit, 34 Period Change Unit, B Threshold Value, CA Carrier Signal, K Coefficient For Evaluation, N Evaluation Value, P Carrier Signal Number, Q Phase Number, TAC AC Period, Tca Carrier Period, Tca1 First Carrier Period, Tca2 Second Carrier Period, Tup Update Period, Tup1 First Update Period, Tup2 Second Update Period

1. A controller for an AC rotary electric machine that controls the AC rotary electric machine which is provided with plural-phase windings via an inverter, the controller for the AC rotary electric machine comprising at least one processor configured to implement:
a voltage command calculator that calculates and updates AC voltage command values of plural-phase applied to the plural-phase windings at an update period;
a PWM controller that generates a carrier signal which has an amplitude according to a DC voltage supplied to the inverter and vibrates at a carrier period, and controls on/off a plurality of switching devices of the inverter, based on a comparison result between the carrier signal and each of the AC voltage command values of plural-phase; and
a period changer that changes one or both of the carrier period and the update period,
wherein the period changer changes one or both of the carrier period and the update period so that an evaluation value does not coincide with a specific value at which components of frequencies lower than an AC period increases in one or more of current, voltage, and power supplied to the plural-phase windings, and wherein the evaluation value is calculated based on a carrier signal number which is a value obtained by dividing the AC period of the AC voltage command values by the carrier period, and the update period.

2. The controller for the AC rotary electric machine according to claim 1,
wherein, when it is in an overmodulation state where a vibration range of the AC voltage command values exceeds a vibration range of the carrier signal, the changer changes one or both of the carrier period and the update period so that the evaluation value does not coincide with the specific value.

3. The controller for the AC rotary electric machine according to claim 1,
wherein the update period is set to a value obtained by dividing the carrier period by n (n is a natural number).

4. The controller for the AC rotary electric machine according to claim 3,
wherein a phase number of the plural-phase windings is Q,
when the evaluation value is defined as N, the carrier signal number is defined as P and a coefficient for evaluation set to a natural number is defined as K, the evaluation value is a value calculated by an equation of “N=n×P×K”, and the coefficient for evaluation is set to a smallest natural number with which the evaluation value becomes a natural number,
the specific value is set to the evaluation value which is an odd number and a value other than a multiple of Q.

5. The controller for the AC rotary electric machine according to claim 4,
wherein the specific value is set to the evaluation value which is an odd number, a value other than a multiple of Q, and a value less than or equal to a threshold value.

6. The controller for the AC rotary electric machine according to claim 1,
wherein the period changer changes one or both of the carrier period and the update period based on the AC period so that the evaluation value does not coincide with the specific value.

7. The controller for the AC rotary electric machine according to claim 6,
wherein, by referring a map data in which a relation between the AC period, and one or both of a setting value of the carrier period and a setting value of the update period with which the evaluation value does not coincide with the specific value is preliminarily set, the period changer calculates and sets one or both of the setting value of the carrier period and the setting value of the update period corresponding to the present AC period.

8. The controller for the AC rotary electric machine according to claim 1,
wherein, under a specific condition where the evaluation value approaches the specific value when the carrier period is set to a preliminarily set first carrier period, the period changer sets the carrier period to a second carrier period which is preliminarily set so that the evaluation value does not coincide with the specific value, and
under other than the specific condition, the period changer sets the carrier period to the first carrier period.

9. The controller for the AC rotary electric machine according to claim 1,
wherein, under a specific condition where the evaluation value approaches the specific value when the carrier period is set to a preliminarily set first carrier period, the period changer changes the carrier period at random, and
under other than the specific condition, the period changer sets the carrier period to the first carrier period.

10. The controller for the AC rotary electric machine according to claim 1,
wherein the PWM controller executes a synchronous PWM mode in which the carrier period is changed in proportion to the AC period, and
when the synchronous PWM mode is executed, the period changer sets a proportional coefficient so that the evaluation value does not coincide with the specific value, and changes the carrier period in proportion to the AC period using the set proportional coefficient.

11. The controller for the AC rotary electric machine according to claim 1,
wherein, under a specific condition where the evaluation value approaches the specific value when the update period is set to a preliminarily set first update period, the period changer sets the update period to a second update period which is preliminarily set so that the evaluation value does not coincide with the specific value, and
under other than the specific condition, the period changer sets the update period to the first update period.
